(19) United States
(12) Patent Application Publication
(10) Pub. No.: US 2026/0237136 A1
(43) Pub. Date: Aug. 13, 2026

(54) SYSTEM FOR PROVIDING REAL-TIME FACIAL TRANSFORMATION SERVICE BASED ON THREE-DIMENSIONAL HOLOGRAM USING ARTIFICIAL INTELLIGENCE

(71) Applicant: Creativemut Co., Ltd., Seoul (KR)

(72) Inventors: Tae Hwan KIM, Seoul (KR); Jong Whan MYOUNG, Incheon (KR)

(73) Assignee: Creativemut Co., Ltd., Seoul (KR)

(21) Appl. No.: 19/530,677

(22) Filed: Feb. 5, 2026

(30) Foreign Application Priority Data
Feb. 7, 2025 (KR) 10-2025-0015959

(51) Int. Cl. G06T 13/40; G03H 1/00; G06T 19/00; G06V 20/20; G06V 40/16

(52) U.S. Cl. CPC G06T 13/40; G03H 1/0005; G06T 19/006; G06V 20/20; G06V 40/161; G06V 40/171; G03H 2001/0088; G03H 2210/30

(57) ABSTRACT

Provided is a system for providing a real-time face transformation service on the basis of a three-dimensional (3D) hologram using artificial intelligence (AI), the system including a hologram device configured to image an object and display a result obtained by transforming a face of the object as a 3D hologram; and a transformation service provision server including a receiver configured to receive captured content obtained by imaging the object, a detector configured to detect the face of the object in the captured content, a transformer configured to output augmented reality (AR) content obtained by animating the face on the detected face, a converter configured to convert the object overlaid with the AR content into a 3D hologram, and a transmitter configured to transmit the 3D hologram to the hologram device such that the 3D hologram is output.

### CROSS-REFERENCE TO RELATED APPLICATION

This application claims priority to and the benefit of Korean Patent Application No. 10-2025-0015959, filed on Feb. 7, 2025, the disclosure of which is incorporated herein by reference in its entirety.

### BACKGROUND

### 1. Field of the Invention

The present invention relates to a system for providing a real-time face transformation service based on a three-dimensional (3D) hologram using artificial intelligence (AI), and more particularly, to a system for detecting a face of an object, overlaying the detected face with augmented reality (AR) content to animate the detected face, converting the object overlaid with the AR content into a 3D hologram, and outputting the 3D hologram.

### 2. Discussion of Related Art

Lately, technologies such as virtual reality (VR), augmented reality (AR), mixed reality (MR), etc., have advanced significantly to provide users with highly immersive experiences using realistic content. Holograms are a technique for projecting virtual content into midair on the basis of interference effects of light. However, holograms currently have limitations in visualizing natural-color content and still face difficulties in expressing content at the same size as objects used in real life. Therefore, a hologram-like technology has been developed to visualize virtual content in actual size within midair. The hologram-like technology offers a floating effect that makes virtual content appear suspended in midair, providing a more realistic experience for a large audience than general displays.

Here, research and development has been conducted on methods to visualize content using pseudo-holograms or transform faces into characters. In this regard, Korean Patent Publication No. 2022-0082427 (published Jun. 17, 2022) and Korean Patent Publication No. 2014-0094981 (published Jul. 31, 2014) which are related art, disclose a configuration for receiving hologram-like system information, converting content in accordance with attribute information of the hologram-like system, and outputting and projecting the converted content to the hologram-like system, and a configuration for extracting a facial contour to set it as a game character, correcting and filtering the extracted image, and mapping the corrected and filtered image to a character within a game, respectively.

However, the former discloses only the configuration for projecting a pseudo-hologram, and the latter discloses only the configuration for converting a face into a character. Lately, hologram devices have been installed at various exhibition facilities like Convention and Exhibition (COEX) Center for promotional purposes, providing a service for capturing images of visitors and display the images on the hologram devices to entertain the visitors. Accordingly, it is necessary to research and develop a system for enhancing advertising effectiveness and providing elements of entertainment by displaying an animated and converted facial result on a hologram device.

### SUMMARY OF THE INVENTION

The present invention is directed to providing a system for providing a real-time face transformation service based on a three-dimensional (3D) hologram using artificial intelligence (AI) that images an object, detects a face of the object, animates of the detected face to output augmented reality (AR) content, converts the object overlaid with the AR content into a 3D hologram, outputs the 3D hologram via a hologram device and thereby enables a user to view his or her own transformed face on the hologram device and keep his or her own appearance output from the hologram device as a commemorative photo or output it to a hologram device in another location, which creates a sense of presence as if he or she had teleported to the other location. However, objects to be achieved by the present invention are not limited to that described above, and other objects may exist.

According to an aspect of the present invention, there is provided a system for providing a real-time face transformation service based on a 3D hologram using AI, the system including: a hologram device configured to image an object and display a result obtained by transforming a face of the object as a 3D hologram; and a transformation service provision server including a receiver configured to receive captured content obtained by imaging the object, a detector configured to detect the face of the object in the captured content, a transformer configured to output AR content obtained by animating the face on the detected face, a converter configured to convert the object overlaid with the AR content into a 3D hologram, and a transmitter configured to transmit the 3D hologram to the hologram device such that the 3D hologram is output.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a system for providing a real-time face transformation service on the basis of a three-dimensional (3D) hologram using artificial intelligence (AI) according to an embodiment of the present invention;

FIG. 2 is a block diagram illustrating a transformation service provision server included in the system of FIG. 1;

FIGS. 3A-3B and 4A-4J are views illustrating an embodiment in which a 3D hologram-based real-time face transformation service employing AI according to an embodiment of the present invention is implemented; and

FIG. 5 is an operational flowchart illustrating a method of providing a real-time face transformation service on the basis of a 3D hologram using AI according to an embodiment of the present invention.

### DETAILED DESCRIPTION OF EXEMPLARY EMBODIMENTS

Hereinafter, embodiments of the present invention will be described in detail with reference to the accompanying drawings such that those skilled in the technical field to which the present invention pertains readily implement the present invention. However, the present invention may be modified in various forms and is not limited to the embodiments described below. To clearly describe the present invention, parts unrelated to the description will be omitted in the drawings. Throughout the present specification, like reference numbers refer to like components.

Throughout the specification, when any one part is referred to as being “connected” to another part, it means that the parts are “directly connected” to each other or “electrically connected” to each other with still another part interposed therebetween. Also, when a certain part “includes” a certain component, it means that other components may be further included, rather than excluding other components, unless otherwise stated, it is to be understood that it does not preclude the possibility of addition or presence of one or more other features, numbers, steps, operations, components, parts, or combinations thereof.
The term “about,” “substantially,” etc., used throughout the specification means figures corresponding to manufacturing and material tolerances specific to the stated meaning and figures close thereto, and are used to prevent unconscionable abusers from unfairly using the disclosure of figures precisely or absolutely described to aid the understanding of the present invention. The term “step” or “step of” does not mean “step for.”
In the specification, the term “unit” includes a unit implemented by hardware, a unit implemented by software, and a unit implemented by both. Further, one unit may be implemented by two or more pieces of hardware, and two or more units may be implemented by one piece of hardware. Meanwhile, a “unit” is not limited to software or hardware, and may be configured to reside in an addressable storage medium or configured to reproduce one or more processors. Therefore, as an example, a “unit” includes components such as software components, object-oriented components, class components, and task components, processes, functions, attributes, procedures, subroutines, segments of program code, drivers, firmware, microcode, circuitry, data, databases, data structures, tables, arrays, and variables. Components and functions provided in “units” may be combined into a smaller number of components and “units” or may be subdivided into additional components and “units.” Further, components and “units” may be implemented to reproduce one or more central processing units (CPUs) in a device or a security multimedia card.

In the specification, some of operations or functions described as being performed by a terminal, an apparatus, or a device may be performed instead in a server connected to the terminal, apparatus, or device. Similarly, some of operations or functions described as being performed by a server may be performed in a terminal, apparatus, or device connected to the server.

In the specification, some of operations or functions described as mapping with or matching a terminal means mapping or matching a unique number of the terminal or personal identification information, which is identifying data of the terminal.

The present invention will be described below with reference to the accompanying drawings.

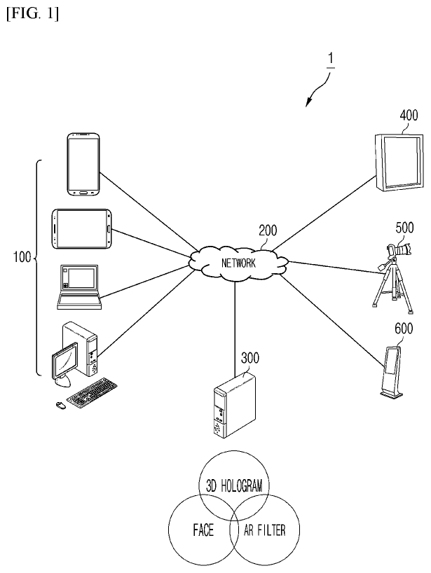

FIG. 1 is a diagram illustrating a system for providing a real-time face transformation service on the basis of a three-dimensional (3D) hologram using artificial intelligence (AI) according to an embodiment of the present invention. Referring to FIG. 1, a system 1 for providing a real-time face transformation service on the basis of a 3D hologram using AI may include at least one user terminal 100, a transformation service provision server 300, at least one hologram device 400, at least one shooting camera 500, and a kiosk 600. However, the system 1 for providing a real-time face transformation service on the basis of a 3D hologram using AI shown in FIG. 1 is merely an embodiment of the present invention, and the present invention is not limited to FIG. 1.

The components of FIG. 1 are generally connected via a network 200. For example, as shown in FIG. 1, the at least one user terminal 100 may be connected to the transformation service provision server 300 via the network 200. The transformation service provision server 300 may be connected to the at least one user terminal 100, the at least one hologram device 400, the at least one shooting camera 500, and the kiosk 600 via the network 200. The at least one hologram device 400 may be connected to the transformation service provision server 300 via the network 200. The at least one shooting camera 500 may be connected to the at least one user terminal 100, the transformation service provision server 300, and the at least one hologram device 400 via the network 200. Finally, the kiosk 600 may be connected to the user terminal 100, the hologram device 400, the transformation service provision server 300, and the at least one shooting camera 500 via the network 200.

Here, a network is a connective structure that allows information to be exchanged between individual nodes such as a plurality of terminals and servers. Examples of a network include a local area network (LAN), a wide area network (WAN), the Internet (the world wide web (WWW)), a wired or wireless data communication network, a telephone network, a wired or wireless television communication network, and the like. Examples of the wireless data communication network include, but are not limited to, a 3^{rd} Generation (3G) network, a 4^{th} Generation (4G) network, a 5^{th} Generation (5G) network, a 3^{rd} Generation Partnership Project (3GPP) network, a 5^{th} Generation Partnership Project (5GPP) network, a 5G New Radio (NR) network, a 6^{th} Generation of cellular networks (6G) network, a Long Term Evolution (LTE) network, a World Interoperability for Microwave Access (WiMAX) network, a Wi-Fi network, the Internet, a LAN, a wireless LAN, a WAN, a personal area network (PAN), a radio frequency (RF) network, a Bluetooth network, a near-field communication (NFC) network, a satellite broadcast network, an analog broadcast network, a digital multimedia broadcasting (DMB) network, and the like.

In the following description, the term “at least one” is defined as a term including the singular and plural meanings. Even when the term “at least one” is not present, each component may be present in a singular or plural form, and it is obvious that the term may have a singular or plural meaning. In addition, the fact that each component is provided in a singular or plural form means that it is changeable in accordance with embodiment.

The at least one user terminal 100 may be a terminal of a user who receives and outputs a commemorative photo obtained by capturing a 3D hologram output through the hologram device 400 via the shooting camera 500 after the user's face is animated and converted into the 3D hologram using a webpage, an app page, a program, or an application related to a 3D hologram-based real-time face transformation service employing AI.

Here, the at least one user terminal 100 may be implemented as a computer that may access a server or a terminal at a remote location via a network. The computer may be, for example, a navigation device, a notebook computer, a desktop computer, a laptop computer, etc., equipped with a web browser. In this case, the at least one user terminal 100 may be implemented as a terminal that may access a server or a terminal at a remote location via a network. The at least one user terminal 100 is, for example, a mobile communication device of which portability and mobility are ensured and may be any type of handheld wireless communication device, such as a Personal Communication System (PCS) terminal, a Global System for Mobile Communications (GSM) terminal, a Personal Digital Cellular (PDC) terminal, a Personal Handyphone System (PHS) terminal, a Personal Digital Assistant (PDA) terminal, an International Mobile Telecommunication (IMT)-2000 terminal, a Code Division Multiple Access (CDMA)-2000 terminal, a wideband CDMA (W-CDMA) terminal, a Wireless Broadband Internet (WiBro) terminal, a smartphone, a smartpad, a tablet personal computer (PC), and the like.

The transformation service provision server 300 may be a server that provides the webpage, the app page, the program, or the application related to the 3D hologram-based real-time face transformation service employing AI. The transformation service provision server 300 may be a server that detects a face of an object, overlays the face with AR content to animate the face, converts the object of which the face is overlaid with the AR content into a 3D hologram, and then transmits the 3D hologram to the hologram device 400. The transformation service provision server 300 may be a server that, when a phone number is input from the kiosk 600, makes the shooting camera 500 to image the object displayed as the 3D hologram on the hologram device 400 and then transmits the commemorative photo to the input phone number, that is, the user terminal 100. When a location is selected in the kiosk 600 to determine a teleport service, the transformation service provision server 300 may be a server that transmits the user's 3D hologram to the hologram device 400 installed at the selected location to output the 3D hologram and relays the result to the kiosk 600 in real time.

The transformation service provision server 300 may be implemented as a computer that may access a server or a terminal at a remote location via a network. Here, the computer may be, for example, a navigation device, a notebook computer, a desktop computer, a laptop computer, etc., equipped with a web browser.

The at least one hologram device 400 may be a device that displays a 3D hologram using the webpage, the app page, the program, or the application related to the 3D hologram-based real-time face transformation service employing AI.

The at least one hologram device 400 may be implemented as a computer that may access a server or a terminal at a remote location via a network. Here, the computer may be, for example, a navigation device, a notebook computer, a desktop computer, a laptop computer, etc., equipped with a web browser. The at least one hologram device 400 may be implemented as a terminal that may access a server or a terminal at a remote location via a network. The at least one hologram device 400 is, for example, a mobile communication device of which portability and mobility are ensured and may be any type of handheld wireless communication device, such as a navigation device, a PCS terminal, a GSM terminal, a PDC terminal, a PHS terminal, a PDA terminal, an IMT-2000 terminal, a CDMA-2000 terminal, a W-CDMA terminal, a WiBro terminal, a smartphone, a smartpad, a tablet PC, and the like.

The at least one shooting camera 500 may be a camera that images the hologram device 400 using the webpage, the app page, the program, or the application related to the 3D hologram-based real-time face transformation service employing AI.

Here, the at least one shooting camera 500 may be implemented as a computer that may access a server or a terminal at a remote location via a network. Here, the computer may be, for example, a navigation device, a notebook computer, a desktop computer, a laptop computer, etc., equipped with a web browser. The at least one shooting camera 500 may be implemented as a terminal that may access a server or a terminal at a remote location via a network. The at least one shooting camera 500 is, for example, a mobile communication device of which portability and mobility are ensured and may be any type of handheld wireless communication device, such as a navigation device, a PCS terminal, a GSM terminal, a PDC terminal, a PHS terminal, a PDA terminal, an IMT-2000 terminal, a CDMA-2000 terminal, a W-CDMA terminal, a WiBro terminal, a smartphone, a smartpad, a tablet PC, and the like.

The kiosk 600 may be a device that receives the user's phone number using the webpage, the app page, the program, or the application related to the 3D hologram-based real-time face transformation service employing AI, receives the selected location where the 3D hologram will be output, and streams a video of an audience in real time by relaying in real time the site where the teleport service is provided.

Here, the kiosk 600 may be implemented as a computer that may access a server or a terminal at a remote location via a network. Here, the computer may by, for example, a navigation device, a notebook computer, a desktop computer, a laptop computer, etc., equipped with a web browser. The kiosk 600 may be implemented as a terminal that may access a server or a terminal at a remote location via a network. The kiosk 600 is, for example, a mobile communication device of which portability and mobility are ensured and may be any type of handheld wireless communication device, such as a navigation device, a PCS terminal, a GSM terminal, a PDC terminal, a PHS terminal, a PDA terminal, an IMT-2000 terminal, a CDMA-2000 terminal, a W-CDMA terminal, a WiBro terminal, a smartphone, a smartpad, a tablet PC, and the like

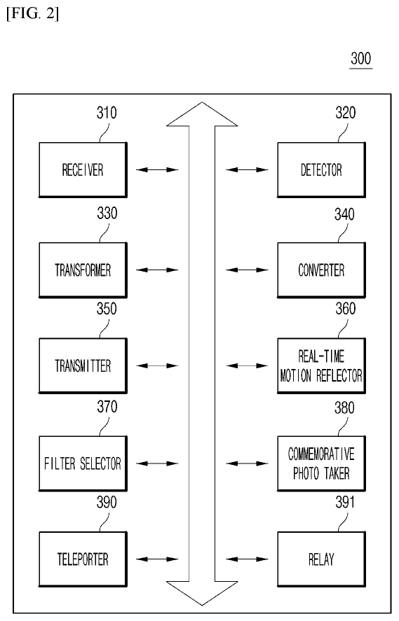

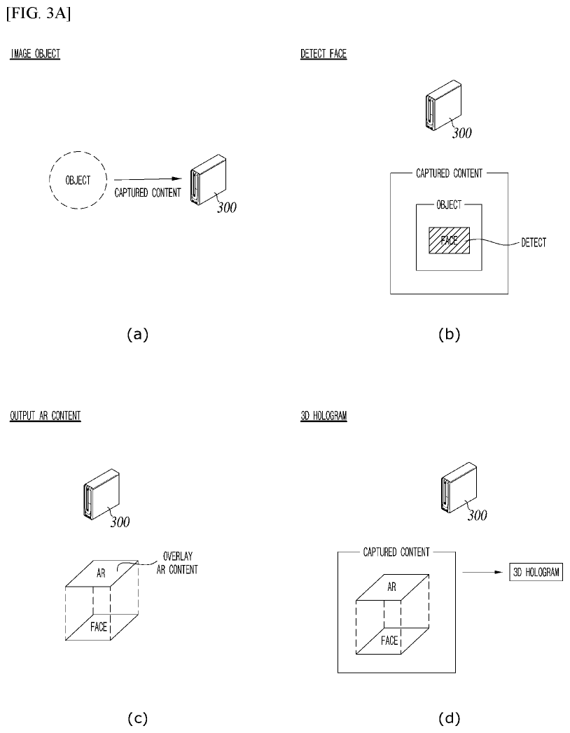

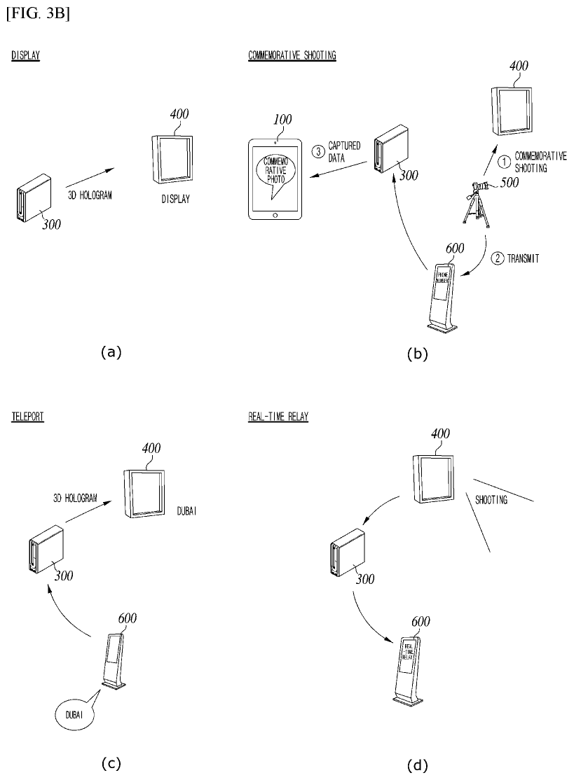

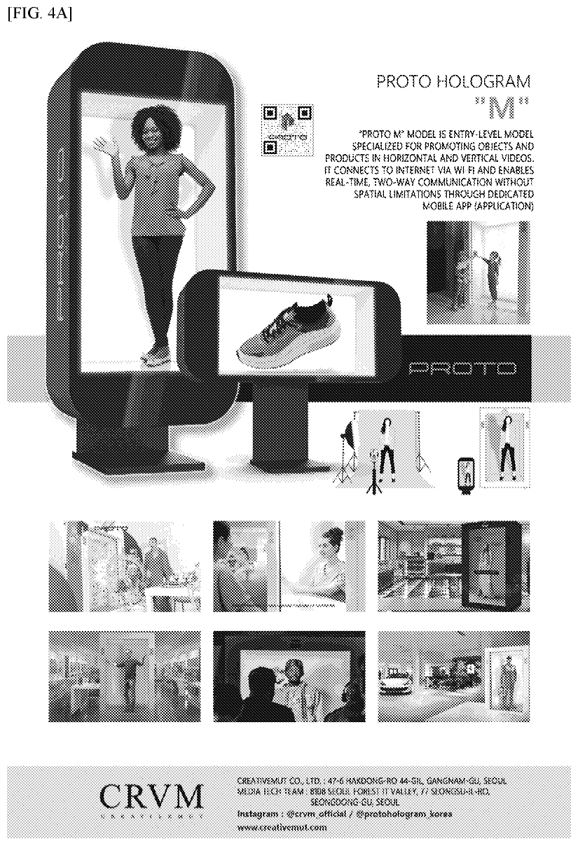

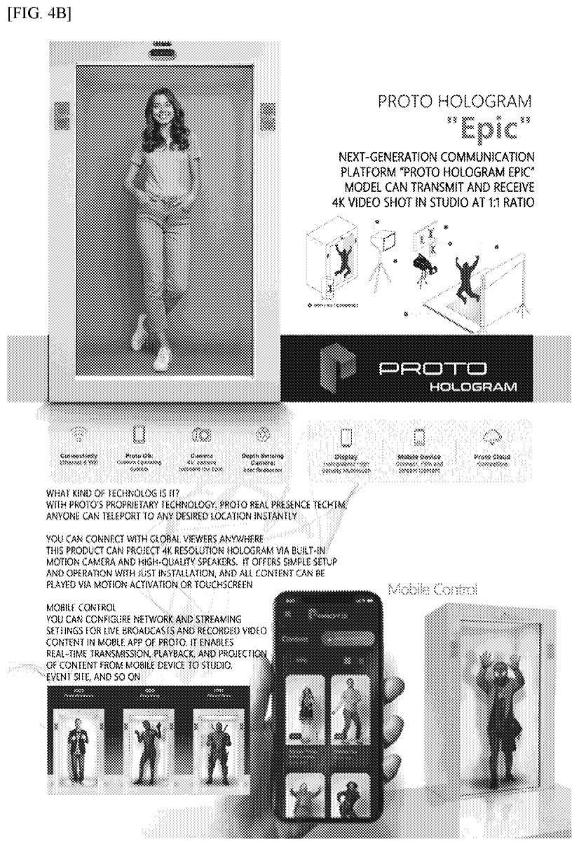

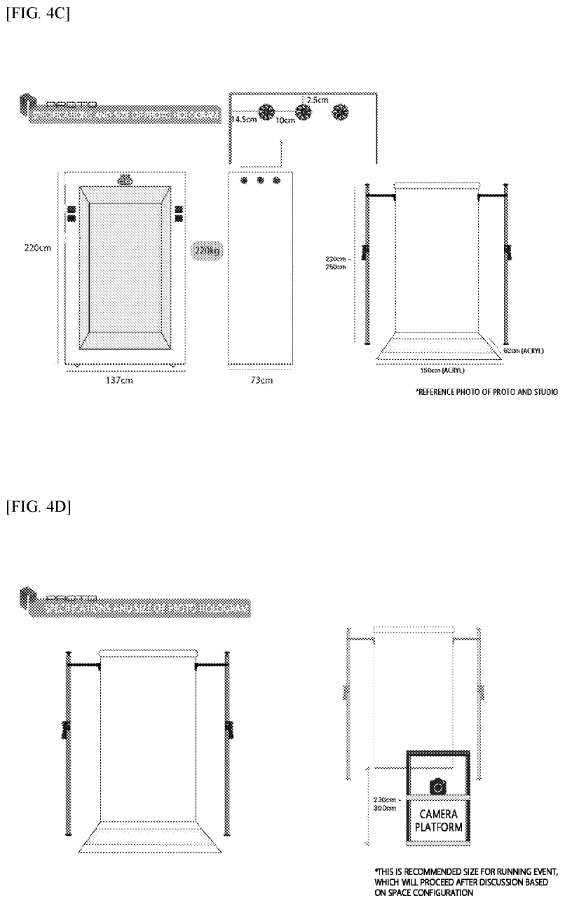

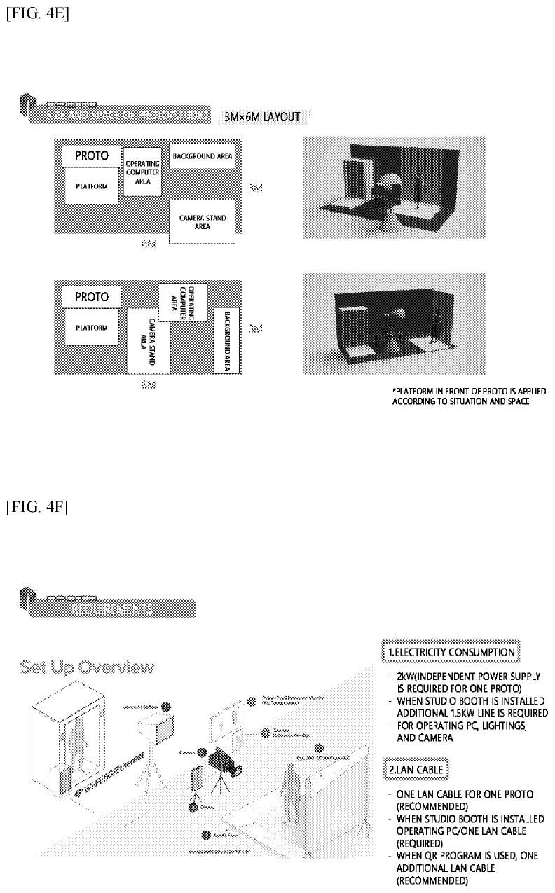

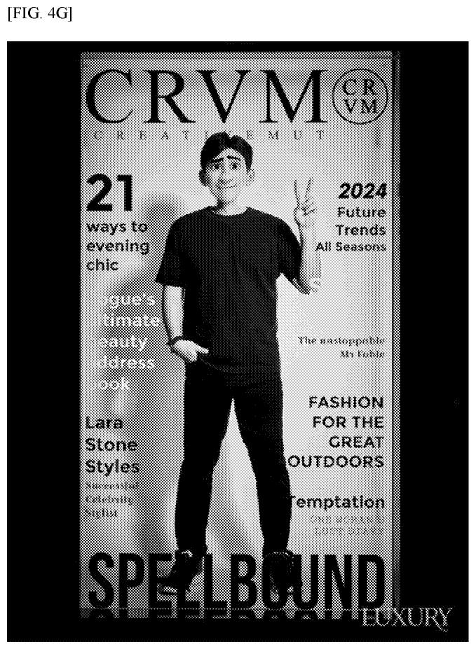

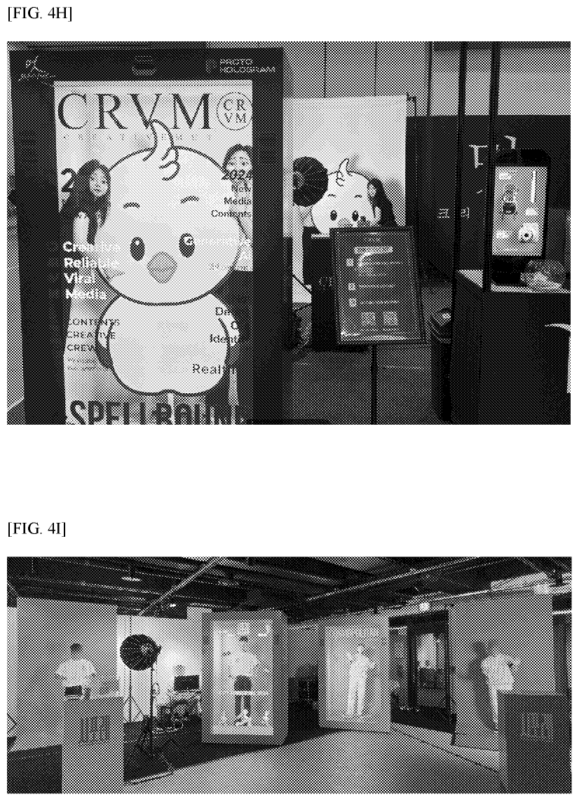

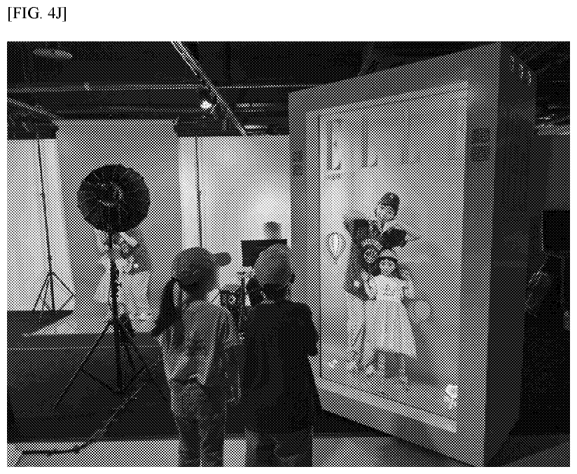

FIG. 2 is a block diagram illustrating a transformation service provision server included in the system of FIG. 1, and FIGS. 3 and 4 are views illustrating an embodiment in which a 3D hologram-based real-time face transformation service employing AI according to an embodiment of the present invention is implemented.

Referring to FIG. 2, the transformation service provision server 300 may include a receiver 310, a detector 320, a transformer 330, a converter 340, a transmitter 350, a real-time motion reflector 360, a filter selector 370, a commemorative photo taker 380, a teleporter 390, and a relay 391.

When the transformation service provision server 300 according to an embodiment of the present invention or another server (not shown) interoperating with the transformation service provision server 300 transmits the application, the program, the app page, the webpage, etc., related to the 3D hologram-based real-time face transformation service employing AI to the at least one user terminal 100, the at least one hologram device 400, the at least one shooting camera 500, and the kiosk 600, the at least one user terminal 100, the at least one hologram device 400, the at least one shooting camera 500, and the kiosk 600 may install or open the application, the program, the app page, the webpage, etc., related to the 3D hologram-based real-time face transformation service employing AI. In addition, a script executed by a web browser may be used to run the service program on the at least one user terminal 100, the at least one hologram device 400, the at least one shooting camera 500, and the kiosk 600. Here, the web browser is a program that enables a user to use a web (WWW) service, that is, a program that receives and shows hypertext described in hypertext markup language (HTML). For example, the web browser is Chrome, Microsoft Edge, Safari, FireFox, Whale, UC browser, and the like. In addition, the application is an application program on a terminal and may be, for example, an app executed on a mobile terminal (smartphone).

Referring to FIG. 2, the receiver 310 may receive captured content obtained by imaging an object. The hologram device 400 may image an object. The imaged object as shown in FIG. 4F may be received as captured content by the receiver 310. Here, the hologram device 400 includes a built-in camera and is connected to a studio camera as shown in FIG. 4F. The captured content is received from the studio camera connected to the hologram device 400. In the present invention, a total of three cameras are used. These cameras are the built-in camera that is installed in the hologram device 400 to image an audience, the studio camera that is connected to the hologram device 400 to image the object and then generate the captured content, and the shooting camera 500 that images a 3D hologram output by the hologram device 400. Since these cameras differ in installation location, subject, etc., it is necessary to distinguish them from each other.

TABLE 1

| | | Installation | Name of |
|---|---|---|---|
| | Subject | location | generated data |
| Built-in | Audience or crowd | Installed in the | Captured data |
| camera | viewing the hologram | foreside of the | |
| | device | hologram device | |
| Studio | Object to be a 3D | Connected to the | Captured |
| camera | hologram | hologram device | content |
| Shooting | Hologram device | Disposed to face | Photo |
| camera | | the hologram | (commemorative |
| | | device | photo) |

The detector 320 may detect a face of the object in the captured content. To this end, an object detection model may be used, and the object detection model may primarily be based on a method of predicting candidate object regions with various sizes on a feature map and efficiently processing the computation of a large number of candidate object regions, for example, faster region-based convolutional neural network (R-CNN) or you only look once (YOLO). Here, RetinaNet uses a feature pyramid network as a baseline to effectively detect small object regions. RetinaFace and TinaFace based thereon also perform face detection using a feature map extracted base on feature pyramid structure.

RetinaFace extracts a feature map with greater precision using two context modules and applies additional information such as face landmarks outside a face region, a 3D mesh of a face, etc., highlighting the distinction between face detection and general object detection. TinaFace employs an inception module to expand receptive fields of feature maps while maintaining computational complexity. Also, an intersection over union (IoU)-based loss function is designed to learn candidate face region prediction with greater precision. Therefore, a platform according to an embodiment of the present invention may employ a method of improving face detection performance by additionally applying an IoU loss function to RetinaFace which is a face detection technology. In this way, it is possible to expand an accommodation region of a feature map, and further improve performance in a small face region by reducing the size of an anchor used for predicting a face region in an image feature map.

### <RetinaFace>

RetinaFace is a face detection model that uses a feature pyramid network as a baseline. Image features extracted from a pretrained ResNet50 are merged into the feature pyramid network, leading to stable operation for detecting faces with various sizes. Five feature maps extracted from the ResNet50 are merged by performing 2× upsampling from the top layer downward and then adding the samples to the lower layers. This process offers the advantage that a feature map of each layer has face region information on a wider range of scales compared to existing feature maps. A context module that performs lateral connection in a channel direction is applied to these feature maps to expand a receptive field and construct a solid structure, and then a loss function is applied. Finally, unlike existing face detection models that only learn correction of face region locations, RetinaFace learns face landmarks and 3D face mesh information using an additional loss function. As a result, RetinaFace shows excellent performance even when fed a smaller-sized face image compared to existing research.

Further details are disclosed in the paper (Deng, Jiankang, J. Guo, Evangelos Verseras, Irene Kotsia, Stefanos Zafeiriou and InsightFace FaceSoft. “Supplementary Materials for: RetinaFace: Single-shot Multi-level Face Localisation in the Wild.” (2020).).

### <TinaFace>

TinaFace argues that face detection is not different from object detection and should have a simplified structure. Similar to existing methods, TinaFace uses a ResNet50-based feature pyramid structure as a baseline. A difference lies in the fact that, instead of a complex channel concatenation of lateral connections, a context module is replaced by an inception module which is widely used when expanding a receptive field. A branch is used to apply an IoU loss function in addition to object classification and a face region regression loss function. In some cases, the effectiveness of a classification loss function in a single-object detector may limit the role of a region regression loss function. To compensate for this, the single-stage detector is configured to additionally learn an IoU which is an overlapping area between the ground truth region and a region predicted by a network. Additionally, detection performance is improved by replacing an existing L1 loss function with a distance-IoU (D-IoU) loss function for face region regression learning. The D-IoU loss function is a learning method in which the L1 loss function of the distance between the center of the ground truth region and the center of a candidate region is added to the IoU loss function.

Further details are disclosed in the paper (Zhu, Yanjia, Hongxiang Cai, Shuhan Zhang, Chenhao Wang and Yichao Xiong. “TinaFace: Strong but Simple Baseline for Face Detection.” ArXiv abs/2011.13183 (2020): n. pag.).

### <Face Detection Model>

According to an embodiment of the present invention, an IoU loss function is added to a RetinaFace model based on an existing face feature point loss function. Also, an existing SSH (Najibi, Mahyar & Samangouei, Pouya & Chellappa, Rama & Davis, Larry. (2017). SSH: Single Stage Headless Face Detector. 4885-4894. 10.1109/UCCV.2017.522.)-based context module is changed to an inception module to expand a receptive field of features extracted from an image and reduce the size of an anchor at the same time, leading to accurate prediction of small-sized face regions. A final loss function used may be Equation 1.

$$L = {L}_{cls} + {L}_{reg} + {L}_{land} + {L}_{IoU} \qquad [ Equation 1 ]$$

L_{cls} is a loss function that learns whether a corresponding region is an object, performing calculation via a cross-entropy loss function by providing 1 as a ground truth label when a given region corresponds to an actual face region, and providing 0 as a ground truth label otherwise. L_{reg} is a regression loss function that learns center coordinates of ground truth regions and heights and widths of the regions via the L1 loss function. L_{land} predicts coordinates of five feature points representing the eyes, the nose, and the mouth and learns using ground truth labels and the L1 loss function. Lastly, L_{IoU} calculates an overlapping area between a predicted region and the ground truth region and applies [1-IoU] as a loss function. Obviously, various methods may be used to detect a face in addition to the foregoing method.

The transformer 330 may output augmented reality (AR) content obtained by animating the face on the detected face. Here, when the face is detected, alignment of the face is determined, and when the alignment and landmarks (feature points) are determined, AR content may be overlaid on the face. Here, the term “using AI” included in the title of the present invention clarifies that the following AI is used for the following “face alignment-face transformation” in the transformer 330.

For example, it is necessary to determine the degree to which a person tilts his or her head downward or turns it to a side to align the eyes, the nose, and the mouth with corresponding points and make the eyes, the nose, and the mouth to conform with the person. Therefore, according to an embodiment of the present invention, sequential attention and a neural network based thereon may be used for face alignment.

### <Face Alignment>

TABLE 2

| | | | | | | | | | | | | | |
|---|---|---|---|---|---|---|---|---|---|---|---|---|---|
| Photo | → | Extract | → | Channel | → | Heatmap | — | — | — | — | ┐ | | |
| | | features | | attention | | regression | | | | | ↓ | | |
| | | \|\| | | | | ↓\| | | | | | ↓ | | |
| | | └\| | | | | Compound | | Channel | | Cascaded | →+ | → | Face |
| | | | | | | attention 1 | | attention 1 | | coordinate | | | alignment 1 |
| | | | | | | | | | | regression 1 | | | |
| | | \| | | | | ↓ | | | | | ┌ | — | ┘ |
| | | . . . | | | | . . . | | . . . | . . . | | . . . | | |
| | | └ | — | — | — | Compound | → | Channel | → | Cascaded | →+ | → | Face |
| | | | | | | attention N | | attention N | | coordinate | | | alignment N |
| | | | | | | | | | | regression N | | | |

“Compound attention-channel attention-cascaded coordinate regression” of Table 2 means a stack of a plurality of layers, and a heatmap regression result represents that compound attentions 1 to Nare input. Table 2 shows a face alignment In Table 2, an attention may use a multi-layer feature map extracted from process. initial neural network layers. Sequential attention includes “compound attention” for applying attention without distinguishing between spatial attention and channel attention using an estimated heatmap and a feature map of each layer and “channel attention” for integrating layers using the same. The dual-structure attention for sequentially performing this process uses a heatmap to induce the neural network to focus on information around landmarks and enhances performance via the diversity of features captured using multi-layer feature maps. The neural network composed of the multi-layer feature maps may also be designed with a sequential cascade structure. A core landmark heatmap is estimated via a stacked hourglass neural network to which channel attention based on a multi-layer feature map is applied, and global core landmark coordinates are estimated from the heatmap. Subsequently, in a cascaded coordinate regression (CCR) operation, a feature map obtained via sequential attention defines regions of interest around the estimated landmark coordinates, and the regions of interest are extracted as feature patches. These patches are used to estimate offset coordinates of the landmarks, and then the offset coordinates are added to the global coordinates from the previous operation to finally estimate coordinates for the current operation.

The basic concepts of the terms derived from the foregoing face alignment are summarized in Tables 3 and 4.

TABLE 3
Face alignment technique

| Coordinate | Input | Network | | | Coordinates |
|---|---|---|---|---|---|
| regression | image | | | | |
| Heatmap | Input | Network | Network | Heatmap | Coordinates |
| regression | image | (Encoder) | (decoder) | | |
| Parameter | Input | Network | | s, R, T | Coordinates |
| regression | image | | | PCA | |
| | | | | parameter | |

TABLE 4
Face alignment technique

| | |
|---|---|
| Coordinate | An output of a deep neural network is defined as |
| regression | face landmark coordinates |
| Heatmap | Includes a post-processing operation of converting |
| regression | a heatmap estimated by a deep neural network with |
| | an encoder-decoder structure into coordinates |
| Parameter | Includes a post-processing operation of estimating |
| regression | principal component analysis (PCA) parameters by |
| | a deep neural network and converting the PCA |
| | parameters into coordinates. These techniques differ |
| | in their characteristics regarding use, execution time, |
| | and accuracy. Research utilizing the fusion of different |
| | kinds of tasks has also been proposed, achieving |
| | enhanced performance. |
| Multitask | A feature map of a higher layer in a deep neural network |
| learning | includes semantic information corresponding to each task. |
| | A deep neural network for single tasks generates a feature |
| | map only for a corresponding task, whereas a deep neural |
| | network for multiple tasks includes semantic information |
| | for all tasks in a feature map. Accordingly, regulations |
| | apply to a single task, and a feature map is augmented, |
| | thereby enhancing a generalization characteristic. |

In summary, it is possible to enhance a feature map via sequential attention based on a landmark heatmap and improve performance to be robust in real-world environments via multitask training of heatmap regression and coordinate regression in a cascaded neural network architecture.

Further details are disclosed in the paper (Newell, Alejandro, Kaiyu Yang and Jia Deng. “Stacked Hourglass Networks for Human Pose Estimation.” European Conference on Computer Vision (2016).). Attention refers to a process of emphasizing certain feature values for a task. Here, the foregoing face alignment method is merely a technique applied according to an embodiment of the present invention, and the present invention is not limited thereto.

### <Face Transformation>

Once the face is detected in the object and the alignment of the detected face is determined, the AR content may be overlaid to match the alignment. The AR content, also known as an AR filter, may be overlaid on the basis of the detected face landmarks. For example, when the face of the object is animated, the face of the object may be tracked on the basis of the landmarks, and the animated face may be moved such that the animated face may continuously move in accordance with movement of the user's face. Image transformation is a field of computer vision that maps an input image belonging to one category to an output image belonging to another category. For example, image transformation is a task of transforming a photo of a person's face into a picture of an animated face. To this end, an embodiment of the present invention may utilize a generative adversarial network (GAN) that employs a multi-scale self-attention module via a cycle contents loss function and adaptive feature map fusion.

Referring to Table 5, image transformation may be divided into two operations. In the first operation, an original image is transformed into an image corresponding to a targeted category. In this operation, an original image x from a source domain passes through a generator (Gs-t) and is converted into a transformed image y′ which is an image of a target domain. This image, that is, the transformed image y′, is passed through a generator (Gt-s) to obtain a restored image x″ which is an image of the source domain. Here, y′ accurately reflects features of x, inducing x″ to be similar to the original image x when restored on the basis of y′. A multi-scale self-attention module and an adaptive feature map fusion technique according to an embodiment of the present invention may be applied to an intermediate stage of the first operation. The generators may have an encoder-decoder architecture. Gs-t transforms an image of a source domain into an image of a target domain, and Gt-s transforms an image of a target domain into a source domain.

In the second operation, the image y′ transformed in the first operation and an actual image y of the target domain are classified by a discriminator (Ds-t), and y′ is induced to accurately reflect features of the target domain. Here, y is a random sample image of the target domain rather than a ground truth image obtained by transforming x into animation, and is only used for providing domain information of data to be transformed. This is because a neural network requires information for understanding characteristics of the target domain to transform the original image x into a target domain style. The cycle contents loss function is applied to a loss function of existing GANs.

TABLE 5
┌—————————Cycle contents loss function—————————┐

| | | ┌———Cycle contents loss function———┐ | | | | | | |
|---|---|---|---|---|---|---|---|---|
| | | Multi- | | | | Multi- | | |
| | | scale | | | | scale | | |
| | | ┌Attention┐ | | | | ┌Attention┐ | | |
| Original | Encoder | | Decoder | Transformed | Encoder | | Decoder | Restored |
| image x | → | | → | image y′ | → | | → | image x″ |
| | Gs-t | | | \| | Gt-s | | | |
| | | Multi- | | \| | | | | |
| | | scale | | | | | | |
| | | ┌Attention┐ | | | | | | |
| Discrimination | Decoder | | Encoder | \| | | | | |
| | ← | | ← | ← | | | | |

| | |
|---|---|
| Ds-t | \| |

Target
image y

In this way, it is possible to address an issue where current applications or programs that animate faces focus solely on image transformation, disregarding the characteristics of the original image and transforming the original image into a different category of image. This is a problem similar to generating arbitrary images corresponding to animated faces by ignoring individuality of facial expressions and hairstyles that appear on human faces. Due to this problem, it is difficult to convert an image into an image of a target field while reflecting characteristics of the image used as the original in the image conversion process. However, according to an embodiment of the present invention, it is possible to convert an image into a target image while preserving unique characteristics of the original image. Obviously, in addition to the foregoing method, various methods may be used to transform a face like animation.

The converter 340 may convert the object of which the face is overlaid with the AR content into a 3D hologram. The 3D hologram may be pseudo hologram or a floating hologram. The applicant according to an embodiment of the present invention uses the hologram device 400 of Proto Hologram Inc. In other words, the hologram device 400 may be the hologram device 400 of Proto Hologram Inc. as shown in FIGS. 4A and 4B. Further details related thereto are disclosed in Korean Patent Application No. 2022-0109379 (published Aug. 4, 2022). When a 3D image of the object is captured as shown in FIGS. 4E, 4F, and 4G and converted into a 3D hologram, the image may be captured in three dimensions using Korean Patent Publication No. 10-2148608 (published Aug. 28, 2020), and the hologram may be generated and output using Korean Patent Publication No. 10-2282407 (published Jul. 28, 2021) and Korean Patent Publication No. 10-2282347 (published Jul. 28, 2021). In this case, to generate a 3D hologram, an imaging method and a 3D hologram generation method of Proto Hologram Inc. may be used as shown in FIGS. 4C to 4F. Further details related thereto are disclosed in Korean Patent Application No. 2022-0109379 (published Aug. 4, 2022). Obviously, in addition to the foregoing method, various methods may be used to perform imaging, measurement, phase detection, and shape restoration for digital holograms.

The transmitter 350 may transmit the 3D hologram to the hologram device 400 such that the 3D hologram is output. The hologram device 400 may display the result obtained by transforming the object's face as the 3D hologram. As shown in FIGS. 4G to 4J, the platform (provisional name “Creativemut”) according to an embodiment of the present invention detects and aligns a face of a captured object, that is, a spectator or visitor, animates the face using a GAN to overlay AR content thereon, converts the result overlaid (combined) with the animated face into a 3D hologram, and outputs the 3D hologram via the hologram device 400. In addition to the animations in the style of FIGS. 4G to 4J, various animation styles may be learned and output. For example, when the target image y in Table 5 is set to the currently popular Disney-style animation, the face may be animated and output in the Disney style. When the target image follows the painting style of Shin Yun-bok, a painter from the Joseon Dynasty, the face may be animated and output in Shin Yun-bok's style. Depending on what kind of target image is set, results may be produced in a variety of styles.

The real-time motion reflector 360 may extract feature points which are one or more landmarks in the face, and transform the AR content in real time to correspond to the feature points. In other words, the animated face may be transformed to conform to a shape, a facial expression, an angle, etc., of the subject's actual face. This may be achieved using an algorithm that animates faces on the basis of each feature point, and game engines such as Unreal, Unity, etc., may be used for this purpose.

When a kiosk connected to the hologram device 400 is provided and a type of AR filter for animating the face is selected in the kiosk, the filter selector 370 may allow transformation of the face based on the selected type of AR filter. When the user wants the Disney style, the filter selector 370 may be adjusted for the face to be animated in the Disney style. When the user wants Shin Yun-bok's style, the face may be transformed into Shin Yun-bok's style.

The commemorative photo taker 380 may receive a photo from the shooting camera 500 for imaging the hologram device 400 when the 3D hologram is displayed, and transmit the received photo to the user terminal when a phone number of the user terminal is input to the kiosk. Since the user may want to image his or her own appearance displayed on the hologram device 400 as shown in FIG. 4J, the commemorative photo taker 380 may make the shooting camera 500 to image the hologram device and, when a phone number is input to the kiosk 600, may transmit the captured photo, that is, the commemorative photo, to the phone number.

When a location where the 3D hologram will be displayed is selected via the kiosk, the teleporter 390 may transmit the 3D hologram to the hologram device 400 installed at the selected location. A plurality of hologram devices 400 may be installed in different locations. For example, it is assumed that Aespa signing event is held at Expo in Samsung-dong and Karina, a member of Aespa, is being projected as a 3D hologram via the hologram device 400. At this time, if fans of Karina are in Osaka, Japan, the 3D hologram can be transmitted to the hologram device 400 installed in Expo City in Osaka. This achieves the effect that Karina is not only present in Samsung-dong, Seoul, but also simultaneously present in Expo City in Osaka, that is, the effect of teleportation.

The relay 391 may stream captured data obtained by imaging in the opposite direction from the built-in camera preinstalled in the hologram device 400 installed in the selected location, to the kiosk 600. Continuing with the foregoing example, when the 3D hologram of Karina from Aespa is being projected on the hologram device 400 at Expo City in Osaka, scenes of the audience, crowd, or passersby captured by the camera built in the hologram device 400 can be displayed on a screen of the kiosk 600 in Samsung-dong, Seoul. In this way, Karina can connect with her fans in Osaka without visiting Osaka, Japan.

An operation process according to the configuration of the transformation service provision server of FIG. 2 described above will be described in detail below using FIGS. 3 and 4 as examples. However, this embodiment is any one of various embodiments of the present invention, and obviously, the present invention is not limited thereto.

Referring to FIG. 3A, when an object is imaged (a), the transformation service provision server 300 detects a face in the object as shown in (b), overlays the face with AR content to animate the face as shown in (c), transforms the object into a 3D hologram as shown in (d), and displays the 3D hologram on the hologram device 400 as shown in (a) of FIG. 3B. The transformation service provision server 300 may image the user output on the hologram device 400 and provide the image as a commemorative photo as shown in (b) or may enable communication with a person in another country or region as shown in (d) by transmitting the 3D hologram to the hologram device 400 in the other country or region as shown in (c).

The hologram device 400 used in an embodiment of the present invention may be the Proto Hologram device shown in FIGS. 4A to 4F. FIG. 4G is a captured image of a 3D hologram displayed after the face of the representative of the platform of the present invention is transformed in real time. By detecting and transforming an object's face in real time as shown in FIGS. 4H to 4J, it is possible to provide fun and attract interest.

Since those that have not been described about a method of providing a real-time face transformation service on the basis of a 3D hologram using AI with reference to FIGS. 2 to 4 are the same as or readily derivable from those previously described about the method of providing a real-time face transformation service on the basis of a 3D hologram using AI with reference to FIG. 1, the description thereof will be omitted.

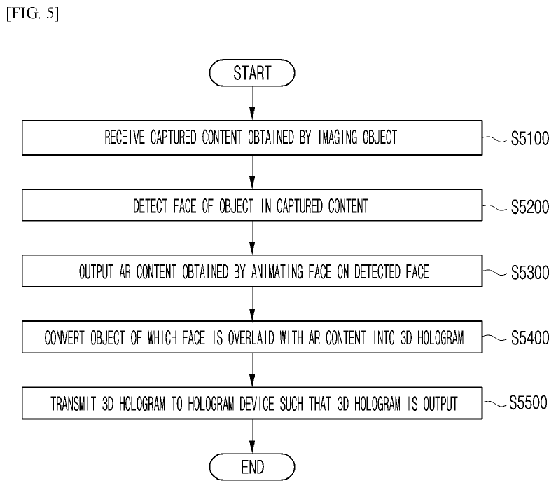

FIG. 5 is an operational flowchart illustrating a process of transmitting and receiving data between components included in the system for providing a real-time face transformation service on the basis of a 3D hologram using AI according to an embodiment of the present invention shown in FIG. 1. An example of the process of transmitting and receiving data between components will be described below with reference to FIG. 5. However, it is obvious to those of ordinary skill in the art that the present invention is not limited to the embodiment and the process of transmitting and receiving data shown in FIG. 5 may vary depending on the various embodiments described above.

Referring to FIG. 5, the transformation service provision server receives captured content obtained by imaging an object (S5100).

The transformation service provision server detects a face of the object in the captured content (S5200) and outputs AR content obtained by animating the face on the detected face (S5300).

The transformation service provision server transforms the object whose face is overlaid with the AR content, into a 3D hologram (S5400) and transmits the 3D hologram to the hologram device such that the 3D hologram may be output (S5500).

The foregoing order of operations S5100 to S5500 is illustrative and is not limited thereto. In other words, the foregoing order of operations S5100 to S5500 may vary, and some of the operations may be simultaneously performed or omitted.

Since those that have not been described about a method of providing a real-time face transformation service on the basis of a 3D hologram using AI with reference to FIG. 5 are the same as or readily derivable from those previously described about the method of providing a real-time face transformation service on the basis of a 3D hologram using AI with reference to FIGS. 1 to 4, the description thereof will be omitted.

The method of providing a real-time face transformation service on the basis of a 3D hologram using AI according to an exemplary embodiment described with reference to FIG. 5 may be implemented in the form of a recording medium including computer-executable instructions such as an application or program module executed by a computer. A computer-readable medium may be any available medium that may be accessed by a computer and includes all of volatile and non-volatile media and removable and non-removable media. Also, the computer-readable medium may include all computer storage media. The computer storage medium includes all of volatile and non-volatile media and removable and non-removable media implemented using any method or technology for storage of information such as computer-readable instructions, data structures, program modules, or other data.

The method of providing a real-time face transformation service on the basis of a 3D hologram using AI according to an exemplary embodiment of the present invention described above may be executed by an application (which may include a program included in a platform, an operating system (OS), etc., basically installed in a terminal) that is basically installed in a terminal, and may be executed by an application (i.e., program) installed directly on a master terminal by a user through an application provision server such as an application store server, an application, or a web server related to the corresponding service. In this sense, the method of providing an 3D hologram-based real-time face transformation service employing AI according to an exemplary embodiment of the present invention described above may be implemented as an application (i.e., program) basically installed in a terminal or directly installed by a user, and may be recorded on a medium that is readable by a computer such as a terminal or the like.

According to any one of the above-described solutions to the present invention, an object may be imaged, a face of the object may be detected, the detected face may be animated to output AR content, the object overlaid with the AR content may be converted into a 3D hologram, and the 3D hologram is output via a hologram device. Accordingly, a user can view his or her own transformed face on the hologram device and keep his or her own appearance output from the hologram device as a commemorative photo or output it to a hologram device in another location, which creates a sense of presence as if he or she had teleported to the other location.

The above description of the present invention is for illustrative purposes, and those of ordinary skill in the art will understand that the present invention may be easily modified into other specific forms without changing the technical spirit or essential features of the present invention. Therefore, it is to be understood that the embodiments described above are illustrative rather than being restrictive in all aspects. For example, each component described as singular may be implemented in a distributed manner, and similarly, components described as distributed may be implemented in a combined form.

It is to be understood that the scope of the present invention will be defined by the claims rather than the above detailed description and all modifications and alterations derived from the meaning and scope of the claims and their equivalents fall within the scope of the present invention.

What is claimed is:

1. A system for providing a real-time face transformation service on the basis of a three-dimensional (3D) hologram using artificial intelligence (AI), the system comprising:
a hologram device configured to image an object and display a result obtained by transforming a face of the object as a 3D hologram; and
a transformation service provision server including a receiver configured to receive captured content obtained by imaging the object, a detector configured to detect the face of the object in the captured content, a transformer configured to output augmented reality (AR) content obtained by animating the face on the detected face, a converter configured to convert the object overlaid with the AR content into a 3D hologram, and a transmitter configured to transmit the 3D hologram to the hologram device such that the 3D hologram is output,
wherein the transformation service provision server further includes a filter selector configured to allow transformation of the face based on a selected type of AR filter when a kiosk connected to the hologram device is provided and the type of AR filter for animating the face is selected in the kiosk.

2. The system of claim 1, wherein the transformation service provision server further includes a real-time motion reflector configured to extract a feature point which is at least one landmark in the face, and transform the AR content in real time to correspond to the feature point.

3. The system of claim 1, wherein the transformation service provision server further includes a commemorative photo taker configured to receive a photo from a shooting camera for imaging the hologram device when the 3D hologram is displayed, and transmit the received photo to a user terminal when a phone number of the user terminal is input to the kiosk.

4. The system of claim 1, wherein the hologram device is a plurality of hologram devices installed at different locations, and
the transformation service provision server further includes a teleporter configured to, when a location where the 3D hologram will be displayed is selected via the kiosk, transmit the 3D hologram to the hologram device installed at the selected location.

5. The system of claim 4, wherein the transformation service provision server further includes a relay configured to stream captured data obtained by imaging in an opposite direction from a built-in camera preinstalled in the hologram device installed in the selected location, to the kiosk.

6. The system of claim 1, wherein the 3D hologram is a pseudo hologram or a floating hologram.
